(19) United States
(12) Patent Application Publication
(10) Pub. No.: US 2018/0373955 A1
(43) Pub. Date: Dec. 27, 2018

(54) LEVERAGING CAPTIONS TO LEARN A GLOBAL VISUAL REPRESENTATION FOR SEMANTIC RETRIEVAL

(71) Applicant: Xerox Corporation, NORWALK, CT (US)

(72) Inventors: Albert Gordo Soldevila, Grenoble (FR); Diane Larlus-Larrondo, La Tronche (FR)

(73) Assignee: Xerox Corporation, NORWALK, CT (US)

(21) Appl. No.: 15/633,892

(22) Filed: Jun. 27, 2017

(51) Int. Cl. G06K 9/62; G06F 17/30

(52) U.S. Cl. CPC G06K 9/6201; G06F 17/30253; G06F 17/30271; G06K 9/6256

(57) ABSTRACT

Similar images are identified by semantically matching human-supplied text captions accompanying training images. An image representation function is trained to produce similar vectors for similar images according to this similarity. The trained function is applied to non-training second images in a different database to produce second vectors. This trained function does not require the second images to contain captions. A query image is matched to the second images by applying the trained function to the query image to produce a query vector, and the second images are ranked based on how closely the second vectors match the query vector, and the top ranking ones of the second images are output as a response to the query image.

### BACKGROUND

Systems and methods herein generally relate to searching image sources, and more particularly to using image queries to search accumulations of stored images.

It is challenging to search accumulations of stored images because often the images within such collections are not organized or classified, and many times the images lack captions or other effective text descriptions. Additionally, user convenience is enhanced when a user is allowed to simply present an undescribed image as a query, and the systems automatically locates similar images to produce an answer to the query image.

Therefore, the task of image retrieval, when given a query image, is to retrieve all images relevant to that query within a potentially very large database of images. Initially this was tackled with bag of-features representations, large vocabularies, and inverted files, and then with feature encodings such as the Fisher vector or the VLAD descriptors, the retrieval task has recently benefited from the success of deep learning representations such as convolutional neural networks that were shown to be both effective and computationally efficient for this task. Among retrieval methods, many have focused on retrieving the exact same instance as in the query image, such as a particular landmark or a particular object.

Another group of methods have concentrated on retrieving semantically related images, where “semantically related” is understood as displaying the same object category or sharing a set of tags. This requires the previous methods herein to make the strong assumption that all categories or tags are known in advance, which does not hold for complex scenes.

### SUMMARY

Various methods herein automatically identify similar images within a training database (that has training images with human-supplied text captions). The similar images are identified by semantically matching the human-supplied text captions (for example, using a processor device electrically connected to an electronic computer storage device that stores the training database). For example, to identify similar images, the process of matching image pairs can be based on a threshold of similarity (e.g., using a hard separation strategy).

These methods also automatically train an image representation function. The image representation function is based on a deep network that transforms image data (and potentially captions) into vectorial representations in an embedding space. Further, the training modifies the weights of the deep network so that the image representation function will produce more similar vectors for similar images, and less similar vectors for dissimilar images where the similar and dissimilar images is information produced by leveraging the human-supplied text captions.

The process of identifying similar images produces matching image triplets consisting of a query image (sometimes also known as an anchor), a relevant image (chosen because it is similar to the query according to the captions), and a non-relevant image (dissimilar according to the captions). More specifically, the training process uses the processor to automatically select a similar image within the training database that is similar to one of the training images within the training database, select a dissimilar image within the training database that is not similar to that training image, and then automatically adjust the weights of the deep network so that the image representation function produces similar vectors for the similar image and the training image, and produces dissimilar vectors for the dissimilar image and the training image. The training repeats the processes of identifying the similar and dissimilar images based on textual captions and adjusting the weights of the image representation function, for thousands of other training image triplets. The image representations produced by the learned image representation function can be compared using distances such as the Euclidean distance or similarity functions such as the dot product.

At some point after training, these methods automatically apply the trained function to second images in a non-training second database to produce second vectors for the second images. The second database is stored in the same or different electronic computer storage device, and is different from the training database. These methods receive (e.g., into the same, or a different, processor device) a query image, with or without captions, and an instruction to find second images in the second database that match the query image. To find images that match the query image, these methods automatically (e.g., using the processor device) apply the trained function to the query image to produce a query vector. This allows these methods to automatically rank the second images based on how closely the second vectors match the query vector, using the processor device, and automatically output (e.g., from the processor device) the top ranking ones of the second images as a response to the query image.

Systems herein include, among other components, one or more electronic computer storage devices that store one or more training databases (having training images with human-supplied text captions) and non-training databases used for deployment, one or more processor devices electrically connected to the electronic computer storage device, one or more input/output devices electrically connected to the processor device, etc.

The processor devices automatically identify similar images within the training database by semantically matching the human-supplied text captions. For example, a process of matching image pairs based on a threshold of similarity (e.g., using a hard separation strategy) can be used to identify similar images.

The processor devices automatically train an image representation function, which processes image data (and potentially captions) into vectors. For example, the processor devices modify the weights of the deep network during training, so that the image representation function will produce more similar vectors for similar images, and less similar vectors for dissimilar images.

The process of identifying similar images produces matching image triplets consisting of a query image (sometimes also known as an anchor), a relevant image (chosen because it is similar to the query according to the captions), and a non-relevant image (dissimilar according to the captions). More specifically, the processor devices automatically select a similar image within the training database that is similar to one of the training images within the training database, select a dissimilar image within the training database that is not similar to that training image, and then automatically adjust the weights of the deep network, so that the image representation function produces similar vectors for the similar image and the training image, and produces dissimilar vectors for the dissimilar image and the training image. During training, the processor devices repeat the processes of identifying the similar and dissimilar images and adjusting the weights of the image representation function, for thousands of other training image triplets. The image representations produced by the learned image representation function can be compared using distances such as the Euclidean distance or similarity functions such as the dot product.

After training, the processor devices automatically apply the trained function to second images in a non-training second database to produce second vectors for the second images. For example, the second database may or may not have captions, can be stored in the same or different electronic computer storage devices, and is different from the training database because the second database is a live, actively used database.

The input/output devices will receive a query image (with or without captions) and an instruction to find the second images in the second database that match the query image. The processor devices automatically apply the trained function to the query image to produce a query vector. The processor devices then automatically rank the second images based on how closely the second vectors match the query vector. Finally, the input/output devices automatically output top ranking ones of the second images as a response to the query image.

These and other features are described in, or are apparent from, the following detailed description.

### BRIEF DESCRIPTION OF THE DRAWINGS

Various exemplary systems and methods are described in detail below, with reference to the attached drawing figures, in which:

FIG. 1 is a relational diagram illustrating operations of methods and systems herein;

FIG. 2 are graphic representations of various metrics herein;

FIGS. 3 and 4 are diagrams of photographs illustrating operations of methods and systems herein;

FIG. 5 is a flow diagram of various methods herein;

FIG. 6 is a schematic diagram illustrating systems herein; and

FIGS. 7 and 8 are schematic diagrams illustrating devices herein.

### DETAILED DESCRIPTION

The systems and methods described herein focus on the task of semantic retrieval on images that display realistic and complex scenes, where it cannot be assumed that all the object categories are known in advance, and where the interaction between objects can be very complex.

Following the standard image retrieval paradigm that targets efficient retrieval within databases of potentially millions of images, these system and methods learn a global and compact visual representation tailored to the semantic retrieval task that, instead of relying on a predefined list of categories or interactions, implicitly captures information about the scene objects and their interactions. However, directly acquiring enough semantic annotations from humans to train such a model is not required. These methods use a similarity function based on captions produced by human annotators as a good computable surrogate of the true semantic similarity, and such provides information to learn a semantic visual representation.

This disclosure presents a model that leverages the similarity between human-generated region-level captions, i.e., privileged information available only at training time, to learn how to embed images in a semantic space, where the similarity between embedded images is related to their semantic similarity. Therefore, learning a semantic representation significantly improves over a model pre-trained on industry standard platforms.

Another variant herein leverages the image captions explicitly and learns a joint embedding for the visual and textual representations. This allows a user to add text modifiers to the query in order to refine the query or to adapt the results towards additional concepts.

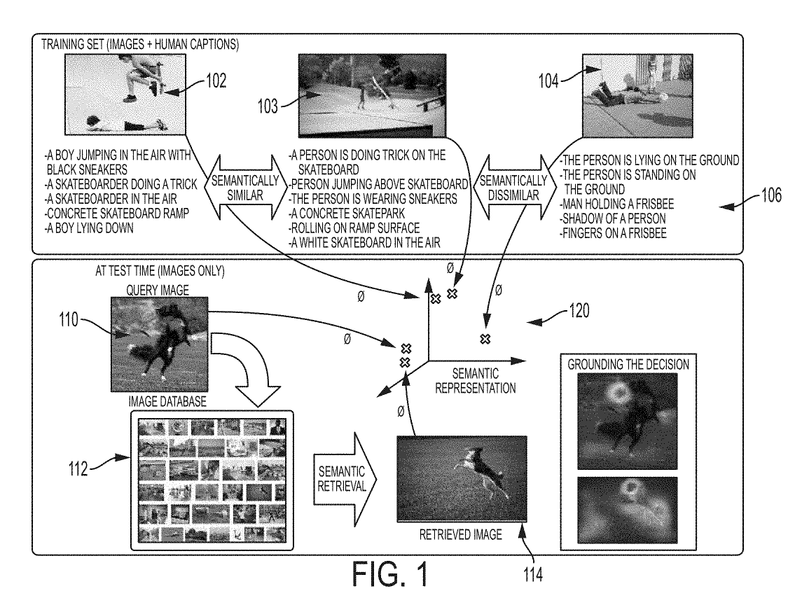

For example, as shown in FIG. 1, leveraging the multiple human captions 106 that are available for images 102-104 of a training set, the systems and methods herein train a semantic-aware representation (shown as vector chart 120) that improves the semantic visual search (using query image 110) within a disjointed database of images 112 that do not contain textual annotations. A search of the database 112 using query image 110 matches image 114.

One underlying visual representation is the ResNet-101 R-MAC network. This network is designed for retrieval and can be trained in an end-to-end manner. The methods herein learn the optimal weights of the model (the convolutional layers and the projections in the R-MAC pipeline) that preserve the semantic similarity. As a proxy of the true semantic similarity these methods leverage the tf-idf-based BoW representation over the image captions. Given two images with captions the methods herein define their proxy similarity s as the dot product between their tf-idf representations.

To train the network, this disclosure presents a method to minimize the empirical loss of the visual samples over the training data. If q denotes a query image, d⁺ a semantically similar image to q, and d⁻ a semantically dissimilar image, the formula defines the empirical loss as L=Σ_{q}Σ_{d}_{⁺}_{,d}_{^{−}}L(q, d⁺, d⁻), where:

L_{υ}(q,d⁺,d⁻)=½max(0,m−ϕ^{T}_{q}ϕ₊+ϕ_{T}^{q}ϕ₋) (Equation 1),

m is the margin and ϕ: I [symbol] ^{D} is the function that embeds the image into a vectorial space, i.e., the output of the model. In what follows, ϕ_{q}, ϕ₊, and ϕ₋ denote ϕ(q), ϕ(d⁺), and ϕ(d⁻). The methods herein optimize this loss with a three-stream network as in with stochastic optimization using ADAM.

To select the semantically similar d⁺ and dissimilar d⁻ images, a hard separation strategy was adopted. Similar to other retrieval works that evaluate retrieval without strict labels, the methods herein considered the nearest k neighbors of each query according to the similarity s as relevant, and the remaining images as irrelevant. This was helpful, as now the goal is to separate relevant images from irrelevant ones given a query, instead of producing a global ranking. In the experiments, the methods herein used k=32, although other values of k led to very similar results. Finally, note that the caption annotations are only needed at training time to select the image triplets, and are not needed at test time.

In the previous formulations, the disclosure only used the textual information (i.e. the human captions) as a proxy for the semantic similarity in order to build the triplets of images (query, relevant and irrelevant) used in the loss function. The methods herein provide a way to leverage the text information in an explicit manner during the training process. This is done by building a joint embedding space for both the visual representation and the textual representation, using two new defined losses that operate over the text representations associated with the images:

Lₜ₁(q,d⁺,d⁻)=½max(0,m−ϕ^{T}_{q}θ₊−ϕ^{T}_{q}θ₋) (Equation 2), and

Lₜ₂(q,d⁺,d⁻)=½max(0,m−θ^{T}_{q}ϕ₊−θ^{T}_{q}ϕ₋) (Equation 3),

As before, m is the margin, ϕ: I→ [symbol] D is the visual embedding of the image, θ: τ→ [symbol] ^{D} and is the function that embeds the text associated with the image into a vectorial space of the same dimensionality as the visual features. The methods herein define the textual embedding as

$$θ ( t ) = \frac{{W}^{T} t}{{‖ {W}^{T} t ‖}_{2}} ,$$

where t is the l₂-normalized tf-idf vector and W is a learned matrix that projects t into a space associated with the visual representation.

The goal of these two textual losses is to explicitly guide the visual representation towards the textual one, which is the more informative representation. In particular, the loss in Equation 2 enforces that text representations can be retrieved using the visual representation as a query, implicitly improving the visual representation, while the loss in Equation 3 ensures that image representations can be retrieved using the textual representation, which is particularly useful if text information is available at query time. All three losses (the visual and the two textual ones) can be learned simultaneously using a siamese network with six streams—three visual streams and three textual streams. Interestingly, by removing the visual loss (Eq. (1)) and keeping only the joint losses (particularly Eq. (2)), one recovers a formulation similar to popular joint embedding methods such as WSABIE or DeViSE. In this case, however, retaining the visual loss is important as the methods herein target a query-by-image retrieval task, and removing the visual loss leads to inferior results.

The following validates the representations produced by the semantic embeddings on the semantic retrieval task and quantitatively evaluates them in two different scenarios. In the first, an evaluation determines how well the learned embeddings are able to reproduce the semantic similarity surrogate based on the human captions. In the second, the models are evaluated using some triplet-ranking annotations acquired from users, by comparing how well the visual embeddings agree with the human decisions on all these triplets. This second scenario also considers the case where text is available at test time, showing how, by leveraging the joint embedding, the results retrieved for a query image can be altered or refined using a text modifier.

The models were benchmarked with two metrics that evaluated how well they correlated with the tf-idf proxy measure, which is the task the methods herein optimized for, as well as with the user agreement metric. Although the latter corresponded to the exact task that the methods herein wanted to address, the metrics based on the tf-idf similarly provided additional insights about the learning process and allow one to cross validate the model parameters. The approach was evaluated using normalized discounted cumulative gain (NDCG) and Pearson's correlation coefficient (PCC). Both measures are designed to evaluate ranking tasks. PCC measures the correlation between ground-truth and predicted ranking scores, while NDCG can be seen as a weighted mean average precision, where every item has a different relevance, which in this case is the relevance of one item with respect to query, measured as the dot product between their tf-idf representations.

To evaluate the method we use a second database of ten thousand images, of which the first one thousand are used as queries. The query image is removed from the results. Finally, because of particular interested in the top results, results using the full list of 10 k retrieved images were not reported. Instead, NDCG and PCC were reported after retrieving the top R results, for different values of R, and plotted the results.

Different versions of the embedding were evaluated. A tuple of the form ({V, V+T}, {V, V+T}) is provided for use herein. The first element denotes whether the model was trained using only visual embeddings (V), as shown in Equation 1, or joint visual and textual embeddings (V+T), as shown in Equations 1-3. The second element denotes whether, at test time, one queries only with an image, using its visual embedding (V), or with an image and text, using its joint visual and textual embedding (V+T). In all cases, the database consists only of images represented with visual embeddings, with no textual information.

This approach was compared to the ResNet-101 R-MAC baseline, pre-trained on ImageNet, with no further training, and to a WSABIE-like model, that seeks a joint embedding optimizing the loss in Equation 2, but does not explicitly optimize the visual retrieval goal of Equation 1.

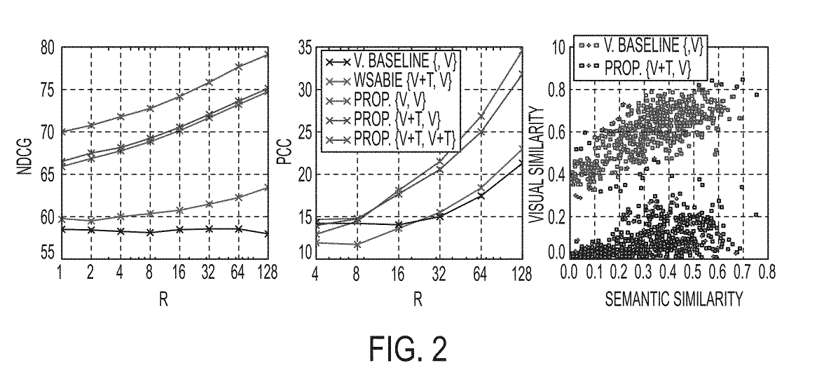

The following discusses the effect of training in the task of simulating the semantic similarity surrogate function and FIG. 2 presents the results using the NDCG@R and PCC@R metrics for different values of R.

A first observation is that all forms of training improve over the ResNet baseline. Of these, WSABIE is the one that obtains the smallest improvement, as it does not optimize directly the retrieval end goal and only focuses on the joint embedding. All methods that optimize the end goal obtain significantly better accuracies. A second observation is that, when the query consists only of one image, training the model explicitly leveraging the text embeddings—models denoted with (V+T, V)—does not seem to bring a noticeable quantitative improvement over (V,V). However, this allows one to query the dataset using both visual and textual information—(V+T, V+T). Using the text to complement the visual information of the query leads to significant improvements.

TABLE 1

| | US | NDCG AUC | PCC AUC |
|---|---|---|---|
| Text Oracle | | | |
| Caption Tf-idf | 77.5 | 100 | 100 |
| Query by image | | | |
| Random (x5) | 49.7 ± 0.8 | 10.2 ± 0.1 | −0.2 ± 0.7 |
| Visual baseline (, V) | 67.5 | 58.4 | 16.1 |
| WSABIE (V + T, V) | 71.4 | 61.0 | 15.7 |
| Proposed (V, V) | 79.6 | 70.0 | 20.7 |
| Proposed (V = T, V) | 79.0 | 70.4 | 20.7 |
| Query by image + text | | | |
| Proposed (V + T, V + T) | 78.9 | 74.1 | 21.4 |

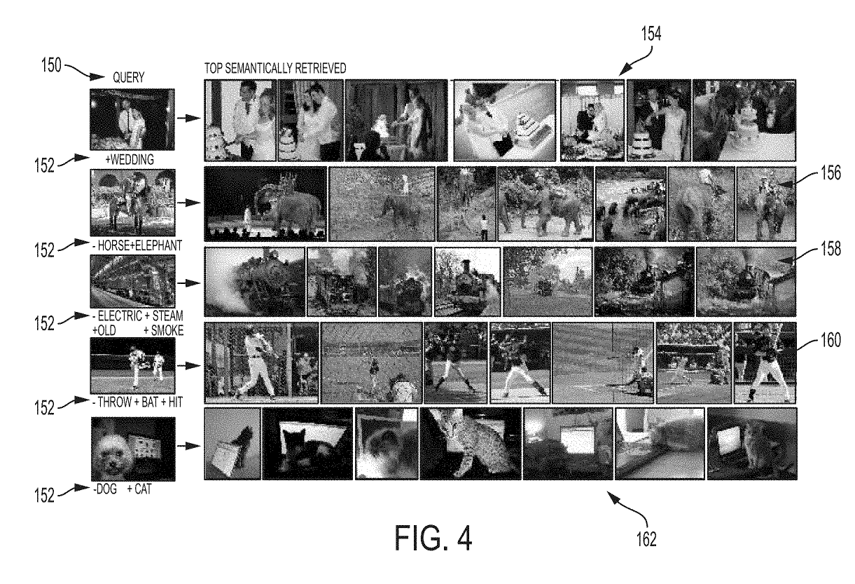

Table 1 (shown above) shows the results of evaluating the methods on the human agreement score and shows the comparison of the methods and baselines evaluated according to User-study (US) agreement score and area under curve (AUC) of the NDCG and PCC curves (i.e. NDCG AUC and PCC AUC). As with NDCG and PCC, learning the embeddings brings substantial improvements in the user agreement score. In fact, most trained models actually outperform the score of the tf-idf over human captions, which was used as a “teacher” to train the model, following the learning with privileged information terminology. The model leverages both the visual features as well as the tf-idf similarity during training, and, as such, it is able to exploit the complementary information that they offer. Using text during testing does not seem to help on the user agreement task, but does bring considerable improvements in the NDCG and PCC metrics. However, having a joint embedding can be of use, even if quantitative results do not improve, for instance for refining the query, see FIG. 4.

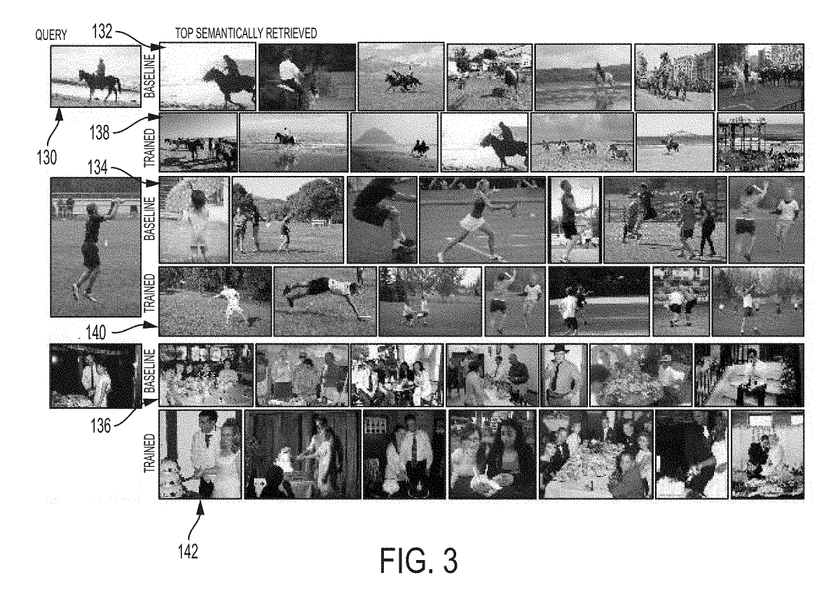

In FIG. 3, the methods compare the visual baseline with the trained method (V+T,V), where the method retrieves more semantically meaningful results, such as horses on the beach or newlyweds cutting a wedding cake. The qualitative results show the query image in the left hand column (item 130). The ‘baseline’ images in the upper rows of items, 132, 134, and 136 shows the representation pre-trained on ImageNet. The ‘trained’ images in the lower rows of items 138, 140 and 142 show the representation from the model that uses the (V+T, V).

FIG. 4 shows the effect of text modifiers. The set of query images in item 150 show the image and plus the text modifier (item 152) as the additional query information (concepts are added or removed) to bias the results, as seen in images of items 154, 156, 158, 160 and 162. The first query image is the same as the last query image in item 136 of FIG. 3 and has now been refined with additional text. The embedding of the query image is combined to the embeddings of textual terms (that can be added or subtracted to the representation) to form a new query with an altered meaning that is able to retrieve different images, and that is only possible thanks to the joint embedding of images and text.

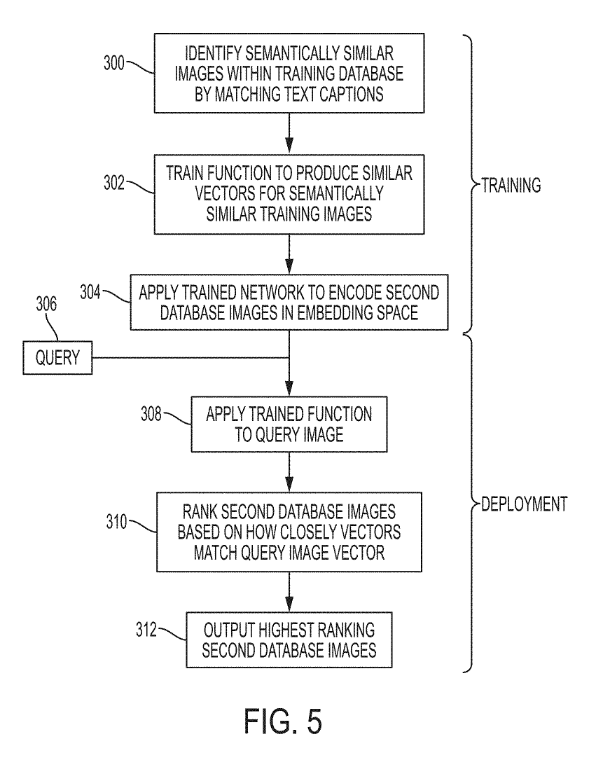

FIG. 5 is flowchart illustrating exemplary methods herein. In item 300, these methods automatically identify similar images within a training database (that has training images with human-supplied text captions). The semantically similar images are identified in item 300 by matching the human-supplied text captions (for example, using a processor device electrically connected to an electronic computer storage device that stores the training database). For example, to identify similar images in item 300, a process of matching image pairs can be based on a threshold of similarity (e.g., using a hard separation strategy).

These methods also automatically train an image representation function, as shown in item 302. The image representation function processes image data (potentially in combination with the captions) into vectors. Further, the training in item 302 modifies the weights of the image representation function so that the image representation function will produce more similar vectors for similar images, and less similar vectors for dissimilar images (for example, again using the processor device).

The process of identifying similar images in item 300 produces matching image pairs, so the training in item 302 can be performed using such matching image pairs. More specifically, the training process in item 302 uses the processor to automatically select a similar image within the training database that is similar to one of the training images within the training database, select a dissimilar image within the training database that is not similar to that training image, and then automatically adjust the weights of the image representation function so that the image representation function produces similar vectors for the similar image and the training image, and produces dissimilar vectors for the dissimilar image and the training image. The training in item 302 repeats the processes of identifying the similar and dissimilar images and adjusting the weights of the image representation function, for thousands of other training images. The image representation function that is trained to produce the similar vectors for the similar images comprises a “trained function.”

At some point after training, these methods automatically apply the trained function to second images in a non-training second database to produce second vectors for the second images, as shown in item 304. The second database is stored in the same or different electronic computer storage device, and is different from the training database. As shown in item 306, these methods receive (e.g., into the same, or a different, processor device) a query image, with or without captions, and an instruction to find second images in the second database that match the query image. To find images that match the query image, these methods automatically (e.g., using the processor device) apply the trained function to the query image to produce a query vector, in item 308. This allows these methods, in item 310, to automatically rank the second images based on how closely the second vectors match the query vector, using the processor device, and automatically output (e.g., from the processor device) the top ranking ones of the second images as a response to the query image, in item 312.

The hardware described herein plays a significant part in permitting the foregoing method to be performed, rather than function solely as a mechanism for permitting a solution to be achieved more quickly, (i.e., through the utilization of a computer for performing calculations). As would be understood by one ordinarily skilled in the art, the processes described herein cannot be performed by a human alone (or one operating with a pen and a pad of paper) and instead such processes can only be performed by a machine (especially when the volume of data being processed, and the speed at which such data needs to be evaluated is considered). For example, if one were to manually attempt to adjust a vector producing function, the manual process would be sufficiently inaccurate and take an excessive amount of time so as to render the manual classification results useless. Specifically, processes such as applying thousands of training images to train a function, calculating vectors of non-training images using the trained function, electronically storing revised data, etc., requires the utilization of different specialized machines, and humans performing such processing would not produce useful results because of the time lag, inconsistency, and inaccuracy humans would introduce into the results.

Further, such machine-only processes are not mere “post-solution activity” because the methods utilize machines at each step, and cannot be performed without machines. The function training processes, and processes of using the trained function to embed vectors are integral with the process performed by the methods herein, and is not mere post-solution activity, because the methods herein rely upon the training and vector embedding, and cannot be performed without such electronic activities. In other words, these various machines are integral with the methods herein because the methods cannot be performed without the machines (and cannot be performed by humans alone).

Additionally, the methods herein solve many highly complex technological problems. For example, as mentioned above, human image classification is slow and very user intensive; and further, automated systems that ignore human image classification suffer from accuracy loss. Methods herein solve this technological problem by training a function using a training set that includes human image classification. In doing so, the methods and systems herein greatly encourage the user to conduct image searches without the use of captions, thus allowing users to perform searches that machines were not capable of performing previously. By granting such benefits, the systems and methods herein solve a substantial technological problem that users experience today.

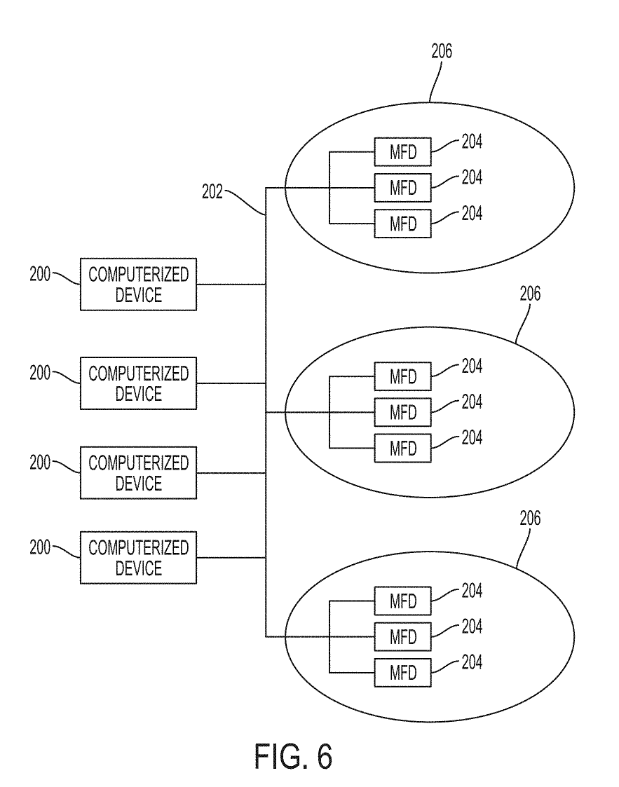

As shown in FIG. 6, exemplary systems and methods herein include various computerized devices 200, 204 located at various different physical locations 206. The computerized devices 200, 204 can include print servers, printing devices, personal computers, etc., and are in communication (operatively connected to one another) by way of a local or wide area (wired or wireless) network 202.

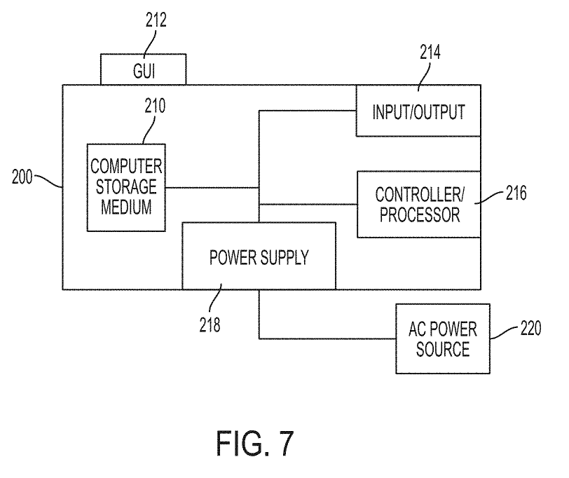

FIG. 7 illustrates a computerized device 200, which can be used with systems and methods herein and can comprise, for example, a print server, a personal computer, a portable computing device, etc. The computerized device 200 includes a controller/tangible processor 216 and a communications port (input/output) 214 operatively connected to the tangible processor 216 and to the computerized network 202 external to the computerized device 200. Also, the computerized device 200 can include at least one accessory functional component, such as a graphical user interface (GUI) assembly 212. The user may receive messages, instructions, and menu options from, and enter instructions through, the graphical user interface or control panel 212.

The input/output device 214 is used for communications to and from the computerized device 200 and comprises a wired device or wireless device (of any form, whether currently known or developed in the future). The tangible processor 216 controls the various actions of the computerized device. A non-transitory, tangible, computer storage medium device 210 (which can be optical, magnetic, capacitor based, etc., and is different from a transitory signal) is readable by the tangible processor 216 and stores instructions that the tangible processor 216 executes to allow the computerized device to perform its various functions, such as those described herein. Thus, as shown in FIG. 7, a body housing has one or more functional components that operate on power supplied from an alternating current (AC) source 220 by the power supply 218. The power supply 218 can comprise a common power conversion unit, power storage element (e.g., a battery, etc), etc.

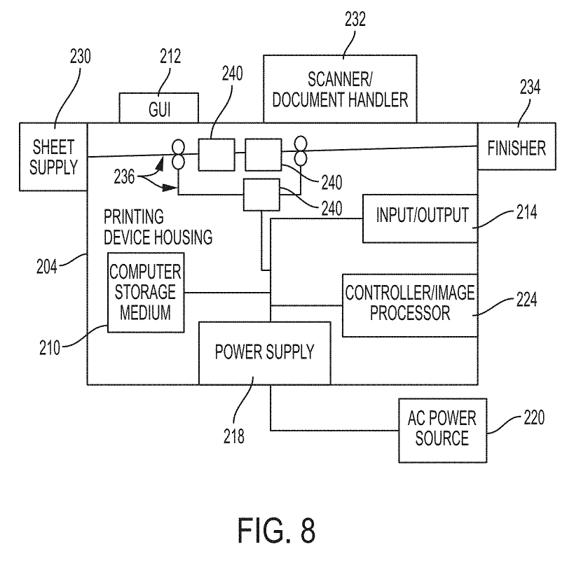

FIG. 8 illustrates a computerized device that is a printing device 204, which can be used with systems and methods herein and can comprise, for example, a printer, copier, multi-function machine, multi-function device (MFD), etc. The printing device 204 includes many of the components mentioned above and at least one marking device (printing engine(s)) 240 operatively connected to a specialized image processor 224 (that is different from a general purpose computer because it is specialized for processing image data), a media path 236 positioned to supply continuous media or sheets of media from a sheet supply 230 to the marking device(s) 240, etc. After receiving various markings from the printing engine(s) 240, the sheets of media can optionally pass to a finisher 234 which can fold, staple, sort, etc., the various printed sheets. Also, the printing device 204 can include at least one accessory functional component (such as a scanner/document handler 232 (automatic document feeder (ADF)), etc.) that also operate on the power supplied from the external power source 220 (through the power supply 218).

The one or more printing engines 240 are intended to illustrate any marking device that applies a marking material (toner, inks, etc.) to continuous media or sheets of media, whether currently known or developed in the future and can include, for example, devices that use a photoreceptor belt or an intermediate transfer belt, or devices that print directly to print media (e.g., inkjet printers, ribbon-based contact printers, etc.).

Therefore, as shown above, systems herein include, among other components, one or more electronic computer storage devices 210 that store one or more training databases (having training images with human-supplied text captions) and non-training databases, one or more processor devices 224 electrically connected to the electronic computer storage device, one or more input/output devices 214 electrically connected to the processor device, etc.

The processor devices 224 automatically identify similar images within the training database by semantically matching the human-supplied text captions. For example, a process of matching image pairs based on a threshold of similarity (e.g., using a hard separation strategy) can be used to identify similar images.

The processor devices 224 automatically train an image representation function, which processes image data (and potentially captions) into vectors. For example, the processor devices 224 modify the weights of the image representation function during training, so that the image representation function will produce more similar vectors for similar images, and less similar vectors for dissimilar images.

The process of identifying similar images produces matching image pairs, so the training can be performed using such matching image pairs. More specifically, the processor devices 224 automatically select a similar image within the training database that is similar to a training image within the training database, select a dissimilar image within the training database that is not similar to the training image, and then automatically adjust the weights of the image representation function, so that the image representation function produces similar vectors for the similar image and the training image, and produces dissimilar vectors for the dissimilar image and the training image. During training, the processor devices 224 repeat the processes of identifying the similar and dissimilar images and adjusting the weights of the image representation function, for thousands of other training images. The image representation function that is trained to produce the similar vectors for the similar images comprises a “trained function.”

After training, the processor devices 224 automatically apply the trained function to second images in a non-training second database to produce second vectors for the second images. For example, the second database may or may not have captions, can be stored in the same or different electronic computer storage devices, and is different from the training database because the second database is a live, actively used database.

The input/output devices 214 will receive a query image (with or without captions) and an instruction to find the second images in the second database that match the query image. The processor devices 224 automatically apply the trained function to the query image to produce a query vector. The processor devices 224 then automatically rank the second images based on how closely the second vectors match the query vector. Finally, the input/output devices 214 automatically output top ranking ones of the second images as a response to the query image.

While some exemplary structures are illustrated in the attached drawings, those ordinarily skilled in the art would understand that the drawings are simplified schematic illustrations and that the claims presented below encompass many more features that are not illustrated (or potentially many less) but that are commonly utilized with such devices and systems. Therefore, Applicants do not intend for the claims presented below to be limited by the attached drawings, but instead the attached drawings are merely provided to illustrate a few ways in which the claimed features can be implemented.

Many computerized devices are discussed above. Computerized devices that include chip-based central processing units (CPU's), input/output devices (including graphic user interfaces (GUI), memories, comparators, tangible processors, etc.) are well-known and readily available devices produced by manufacturers such as Dell Computers, Round Rock Tex., USA and Apple Computer Co., Cupertino Calif., USA. Such computerized devices commonly include input/output devices, power supplies, tangible processors, electronic storage memories, wiring, etc., the details of which are omitted herefrom to allow the reader to focus on the salient aspects of the systems and methods described herein. Similarly, printers, copiers, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known and are not described in detail herein to keep this disclosure focused on the salient features presented. The systems and methods herein can encompass systems and methods that print in color, monochrome, or handle color or monochrome image data. All foregoing systems and methods are specifically applicable to electrostatographic and/or xerographic machines and/or processes.

Further, the terms automated or automatically mean that once a process is started (by a machine or a user), one or more machines perform the process without further input from any user. In the drawings herein, the same identification numeral identifies the same or similar item.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. Unless specifically defined in a specific claim itself, steps or components of the systems and methods herein cannot be implied or imported from any above example as limitations to any particular order, number, position, size, shape, angle, color, or material.

What is claimed is:

1. A method comprising:
automatically identifying similar images within a training database, having training images with human-supplied text captions, by semantically matching said human-supplied text captions, using a processor device electrically connected to an electronic computer storage device that stores said training database;
automatically training an image representation function, which processes image data into vectors, to produce similar vectors for said similar images, using said processor device, said image representation function that is trained to produce said similar vectors for said similar images comprises a trained function;
automatically applying said trained function to second images in a second database to produce second vectors for said second images, using said processor device, said second database is stored in said electronic computer storage device and is different from said training database;
receiving a query image without captions, and an instruction to find ones of said second images that match said query image, into said processor device;
automatically applying said trained function to said query image to produce a query vector, using said processor device;
automatically ranking said second images based on how closely said second vectors match said query vector, using said processor device; and
automatically outputting top ranking ones of said second images as a response to said query image from said processor device.

2. The method according to claim 1, said identifying similar images produces matching image triplets.

3. The method according to claim 2, said matching image triplets are identified using a threshold of similarity.

4. The method according to claim 1, said training uses said processor device to automatically:
select a similar image within said training database that is similar to a training image within said training database;
select a dissimilar image within said training database that is not similar to said training image; and
adjust weights of said image representation function to produce similar vectors for said similar image and said training image, and to produce dissimilar vectors for said dissimilar image and said training image.

5. The method according to claim 4, said training uses said processor device to automatically repeat processes of identifying said similar image and said dissimilar image, and adjusting said weights of said image representation function, for other ones of said training images.

6. The method according to claim 1, said second images lack captions.

7. The method according to claim 1, said processor device comprising one or more processor devices, and said electronic computer storage device comprises one or more electronic computer storage devices.

8. A method comprising:
automatically identifying similar images within a training database, having training images with human-supplied text captions, by semantically matching said human-supplied text captions, using a processor device electrically connected to an electronic computer storage device that stores said training database;
automatically training an image representation function, which processes image data and captions into vectors, to produce similar vectors for said similar images, using said processor device, said image representation function that is trained to produce said similar vectors for said similar images comprises a trained function;
automatically applying said trained function to second images in a second database to produce second vectors for said second images, using said processor device, said second database is stored in said electronic computer storage device and is different from said training database;
receiving a query image with captions, and an instruction to find ones of said second images that match said query image, into said processor device;
automatically applying said trained function to said query image to produce a query vector, using said processor device;
automatically ranking said second images based on how closely said second vectors match said query vector, using said processor device; and
automatically outputting top ranking ones of said second images as a response to said query image from said processor device.

9. The method according to claim 8, said identifying similar images produces matching image triplets.

10. The method according to claim 9, said matching image triplets are identified using a threshold of similarity.

11. The method according to claim 8, said training uses said processor device to automatically:
select a similar image within said training database that is similar to a training image within said training database;
select a dissimilar image within said training database that is not similar to said training image; and
adjust weights of said image representation function to produce similar vectors for said similar image and said training image, and to produce dissimilar vectors for said dissimilar image and said training image.

12. The method according to claim 11, said training uses said processor device to automatically repeat processes of identifying said similar image and said dissimilar image, and adjusting said weights of said image representation function, for other ones of said training images.

13. The method according to claim 8, said second images have captions.

14. The method according to claim 8, said processor device comprising one or more processor devices, and said electronic computer storage device comprises one or more electronic computer storage devices.

15. A system comprising:
an electronic computer storage device that stores a training database having training images with human-supplied text captions;
a processor device electrically connected to said electronic computer storage device; and
an input/output device electrically connected to said processor device,
said processor device automatically identifies similar images within said training database by semantically matching said human-supplied text captions,
said processor device automatically trains an image representation function, which processes image data into vectors, to produce similar vectors for said similar images,
said image representation function that is trained to produce said similar vectors for said similar images comprises a trained function,
said processor device automatically applies said trained function to second images in a second database to produce second vectors for said second images,
said second database is stored in said electronic computer storage device and is different from said training database,
said input/output device receives a query image without captions, and an instruction to find one of said second images that match said query image,
said processor device automatically applies said trained function to said query image to produce a query vector,
said processor device automatically ranks said second images based on how closely said second vectors match said query vector, and
said input/output device automatically outputs top ranking ones of said second images as a response to said query image.

16. The system according to claim 15, said processor device automatically identifies similar images by matching image triplets.

17. The system according to claim 16, said processor device automatically identifies said matching image triplets using a threshold of similarity.

18. The system according to claim 15, said processor device trains said image representation function by automatically:
identifying a similar image within said training database that is similar to a training image within said training database;
identifying a dissimilar image within said training database that is not similar to said training image; and
adjusting weights of said image representation function to produce similar vectors for said similar image and said training image, and to produce dissimilar vectors for said dissimilar image and said training image.

19. The system according to claim 18, said processor device trains said image representation function by automatically repeating said identifying a similar image, said identifying a dissimilar image, and said adjusting weights of said image representation function for other ones of said training images.

20. The system according to claim 15, said second images lack captions.
